(19) United States
(12) Patent Application Publication
(10) Pub. No.: US 2004/0180637 A1
(43) Pub. Date: Sep. 16, 2004

(54) Wireless communication IC and wireless communication information storage medium using the same

(76) Inventors: Nobuyuki Nagai, Tsukuba-gun (JP); Shin Shimizu, Kawasaki-shi (JP)

Correspondence Address: BIRCH STEWART KOLASCH & BIRCH, PO BOX 747, FALLS CHURCH, VA, 22040-0747, US

(21) Appl. No.: 10/796,122

(22) Filed: Mar. 10, 2004

(30) Foreign Application Priority Data
Mar. 11, 2003 (JP) 2003-064466

(51) Int. Cl. G06K 19/06

(52) U.S. Cl. 455/127.1

(57) ABSTRACT

A wireless communication IC exchanges data with an external device by receiving a radio signal having a given carrier frequency as power supply from the external device through an antenna. The wireless communication IC includes a capacitor for storing electric power, a diode placed between one end of the antenna and the capacitor, for supplying a charge current of the radio signal to the capacitor on a half cycle of the received radio signal; and a load modulation circuit. The load modulation circuit is driven by receiving power supply from the capacitor on another half cycle of the radio signal different from a half cycle for supplying a charge current to the capacitor.

### CROSS-REFERENCE TO RELATED APPLICATION

The present invention is related to Japanese Patent Application Serial No. 2003-64466 and 2004-36143, which are hereby incorporated.

### BACKGROUND OF THE DISCLOSURE

1. Field of the Invention

The present invention relates to a wireless communication IC and a wireless communication information storage medium. More particularly, the present invention relates to an improved technique for ensuring the operational stability of a wireless communication IC which exchanges data with an external device by receiving power supply from the device coupled through a coil by electromagnetic induction, used in systems including an IC card reader/writer (hereinafter referred to simply as a “reader/writer”) for contactless data communication with an information medium such as an IC card, a product identification and control device for inventory control of products to which an IC tag is attached, and a device for electronic transaction using an information medium such as an electronic key.

2. Description of the Related Art

A system using a card instead of a key when entering or leaving a building or a room of a company, apartment, and so on is conventionally known. Similar to this system is a gate control system mainly used for an automatic ticket gate.

In these systems, a terminal having a reader/writer function is installed near a door in a doorway or at a ticket gate. The validity of a card is determined by checking up the information recorded on the card, such as a password and an identification code, against the information stored in the terminal or a host computer connected to the terminal, such as a password, an identification code, and an expiration date. After verifying a card user in this way, the door is unlocked to permit access or the ticket gate is opened to permit pass-through by operating an unlocking unit or deactivating a gate closing mechanism.

As a card used in these systems, contactless IC cards have been put into practical use. The contactless IC cards exchange data with a reader/writer by electromagnetic induction or electromagnetic coupling. Conventional contactless IC cards contain a battery. In recently available contactless IC cards, IC driving power is reduced and the power is supplied by a radio wave as described in Japanese Unexamined Patent Application Publication No. 08-330840 and No. 2000-172793.

Further, an IC chip with several mm square where a coil of several tens of turns with ten and several μm in width is formed by electroforming technology with an insulating layer interposed therebetween has been recently used for an IC card or an IC tag to be attached to a product. Such an IC chip is one type of contactless information media and is put into practice as a wireless communication IC (The term “wireless communication IC” used here includes IC tags and other IC contactless information media).

A data exchange system using the wireless communication IC is divided to several types including a close-coupled type in which a distance to a contactless IC card or IC tag is about 0 mm to 2 mm, and a proximity type in which the distance is about 2 mm to 10 cm. The wireless communication IC in the data exchange system communicates data in contact or close proximity to a reader/writer that is an external device. Generally, data communication between the wireless communication IC and the reader/writer uses a modulation technique of ASK (Amplitude Shift Keying) or FSK (Frequency Shift Keying). When supplying electric power to the wireless communication IC, an unmodulated radio wave with a constant amplitude frequency is sent from the external device to the wireless communication IC. The wireless communication IC operates by this electric power and returns a response to the reader/writer. The wireless communication IC may perform data transmission to the reader/writer with load modulation.

FIG. 3 shows a circuit of a wireless communication IC adopting the load modulation. As illustrated in FIG. 3, a wireless communication IC 10 contains a logic circuit 3 having a control circuit 3a, memory 3b, and so on, a load modulation circuit 4, a diode D₁, and a capacitor 5 as a power source. An antenna coil 6 for wireless communication IC (hereinafter referred to simply as the antenna coil 6) is connected to the wireless communication IC 10. The wireless communication IC 10 and the antenna coil 6 makes up a coil-on-chip 2. The antenna coil 6 is coupled by electromagnetic induction to an antenna coil 7 for external device (hereinafter simply as the antenna coil 7) mounted on an external device such as a reader/writer, thereby enabling data transmission between the wireless communication IC 10 and the external device.

The load modulation circuit 4 transmits data by changing the shunt impedance of both terminals 6a and 6b of the antenna coil 6. Thus, a series circuit 4a where a P-channel MOS transistor Tr and a resistor R₁ are connected in this order is provided between the terminals 6a and 6b.

An on/off signal, or a modulation signal MOD, according to transmit data is sent to a gate terminal of the transistor Tr from an output terminal 3c of the logic circuit 3. The transistor Tr turns on and off according to the modulation signal MOD. Switching the transistor Tr from on to off changes the impedance from high impedance at on-state to low impedance with several hundreds ohms at off-state. Several percent to several tens of percent of an amplitude change is thereby made to a carrier wave signal, which modulates the signal.

Consequently, the waveform of the modulated signal becomes as shown in FIG. 4. This is a patterned waveform of a carrier signal with a frequency of 13.56 MHz, which is a standardized frequency for the proximity-type and a load modulated signal with a transmission rate of 26.48 kbps.

The load-modulated current is then half-wave rectified by the diode D₁ between the terminal 6a and the capacitor 5. The capacitor 5 for power storage is charged with this rectified current as a power source with a voltage of V_{DD}. Since the modulated waveform is superposed on the charge signal waveform as shown in FIG. 4, a ripple is added to the power voltage V_{DD}. The power voltage V_{DD} thereby becomes unstable.

The external device receives the load-modulated signal by electromagnetic induction. Thus, though the amplitude of the signal changes by several percent to several tens of percent according to the modulation in the wireless communication IC 10, the external device can detect only several percent of the amplitude change. Hence, if the power voltage V_{DD} at the capacitor 5 becomes unstable, the external device fails to accurately receive data from the wireless communication IC 10, causing the problem that data receive errors are likely to occur.

### SUMMARY OF THE INVENTION

In view of the foregoing, it is an object of the present invention to provide a wireless communication IC that overcomes the drawbacks of the conventional techniques by reducing data receive errors in transmission from the wireless communication IC to an external device to ensure the operational stability of the wireless communication IC, and a wireless communication information storage medium using the wireless communication IC.

To these ends, according to one aspect of the present invention, there is provided a wireless communication IC for exchanging data with an external device by receiving a radio signal having a given carrier frequency as power supply from the external device through an antenna, including a capacitor storing electric power, a diode placed between one end of the antenna and the capacitor, supplying a charge current of the radio signal to the capacitor on a half cycle of the radio signal, and a load modulation circuit driven by receiving power supply from the capacitor on another half cycle of the radio signal. There is also provided a wireless communication information storage medium using this wireless communication IC.

According to another aspect of the present invention, there is provided a wireless communication IC including a drive circuit connected to one end of an antenna to which a diode for rectifying a received wave signal is connected and operating with power supply from a capacitor upon receiving a radio signal on a half cycle different from a half cycle for charging through the end of the antenna. There is also provided a wireless communication information storage medium using this wireless communication IC.

In this configuration, load modulation of a carrier wave signal is performed on a half cycle of the signal different from a half cycle for charging the capacitor Hence, the capacitor is charged with a career signal which is not load-modulated. Thus, the capacitor voltage is unaffected by the load modulation. This stabilizes the capacitor voltage for power supply in spite of the load modulation, thereby reducing data receive errors in data transmission from the wireless communication IC to the external device.

As described in the foregoing, a wireless communication IC according to this invention is provided with a drive circuit connected to one end of an antenna to which a diode for rectifying a received wave signal is connected and operating by power supply from a capacitor. The drive circuit is driven upon receipt of a radio signal on a half cycle different from a half cycle for charging through the end of the antenna.

Since load modulation of a carrier wave signal is performed on a half cycle of the signal different from a half cycle for charging the capacitor, the capacitor is charged with a career signal not load-modulated. Thus, the capacitor voltage is unaffected by the load modulation. This stabilizes the capacitor voltage for power supply in spite of the load modulation, thereby reducing data receive errors in data transmission from the wireless communication IC to the external device.

Further, since this configuration performs load modulation by a half cycle of a wave signal which has not been used in conventional techniques, it enables effective use of power supply.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a circuit diagram of a wireless communication IC according to one embodiment of the present invention.

FIG. 2 is an explanatory diagram of power supply timing in a wireless communication IC according to one embodiment of the present invention.

FIG. 3 is an explanatory diagram of a conventional wireless communication IC using load modulation.

FIG. 4 is an explanatory diagram of a modulated waveform by load-modulation in a close-coupled wireless communication IC.

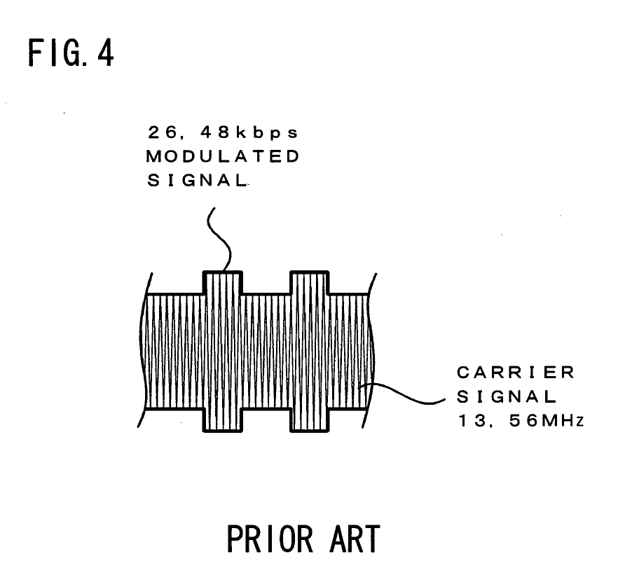

### DESCRIPTION OF THE PREFERRED EMBODIMENTS

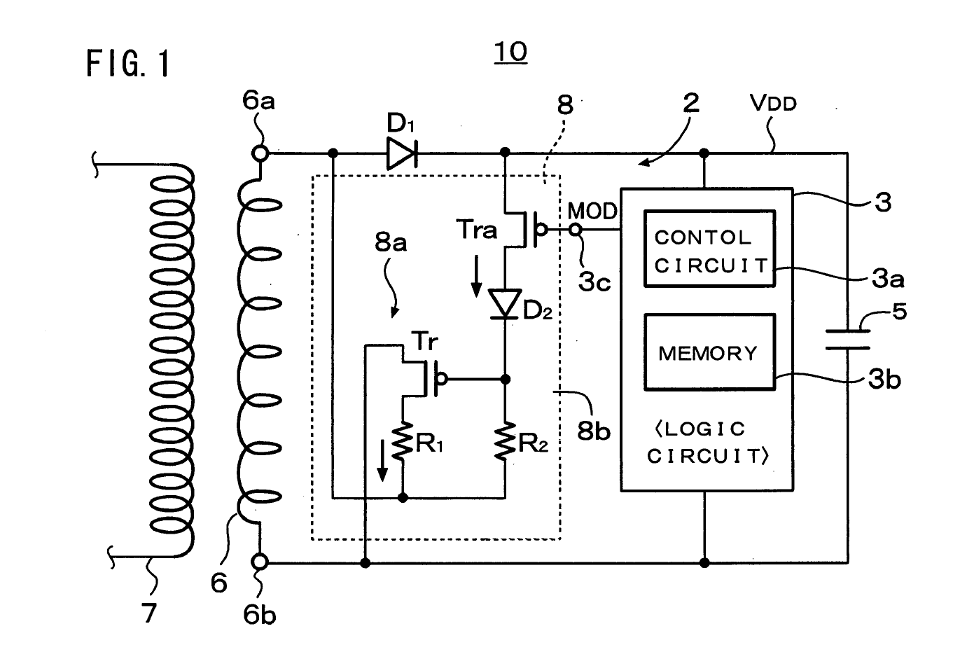

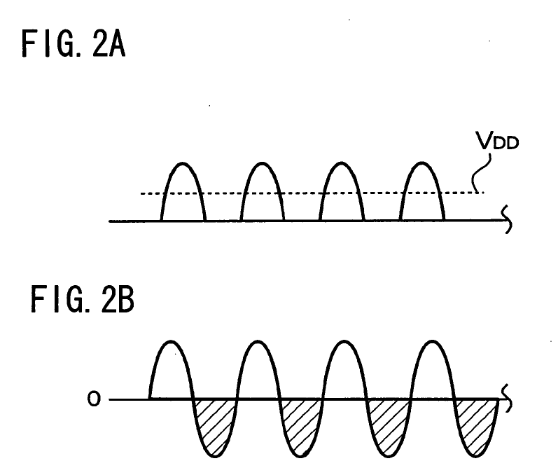

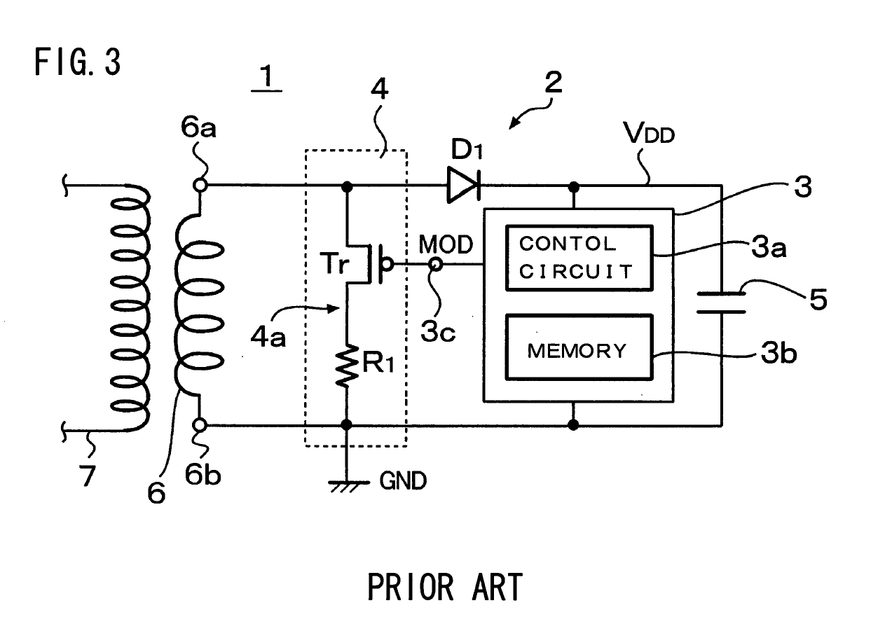

FIG. 1 is a circuit diagram of an embodiment employing a wireless communication IC according to the present invention. FIG. 2 is an explanatory diagram of power supply timing in the embodiment. The same elements as in FIG. 3 are denoted by the same reference symbols and redundant description is omitted.

As shown in FIG. 1, a wireless communication IC 1 has a load-modulation circuit 8 instead of the load-modulation circuit 4 in FIG. 3.

The load-modulation circuit 8 has a series circuit 8a where a resistor R₁ and a transistor Tr are connected in series in this order, which is in a reverse order from the series circuit 4a in FIG. 3, between the terminals 6a and 6b of the antenna coil 6. Further, a drive circuit 8b where a P-channel transistor Tra, a diode D₂, and a resistor R₂ are connected in series in this order is provided between the cathode of the diode D₁ and the terminal 6a.

The drive circuit 8b operates with electric power from the capacitor 5. A connection of the diode D₂ and the resistor R₂ is connected to the gate of the transistor Tr. The gate of the transistor Tra is connected to the output terminal 3c of the logic circuit 3. The resistor R₂ is a bias resistor to the transistor Tr, and the transistor Tr turns on and off according to a terminal voltage determined by the resistor R₂.

Now, a power supply operation in the wireless communication IC according to one embodiment of the present invention will be explained with reference to FIGS. 1 and 2. A signal with a sinusoidal waveform is supplied as a carrier wave signal of 13.56 MHz to the terminals 6a and 6b from an external device through the antenna coil 7. The signal is rectified by the diode D₁ and the capacitor 5 is charged with a positive half-wave (a positive half cycle) as shown in FIG. 2A. In a negative half-wave (negative half cycle) indicated by hatching in FIG. 2B, the terminal 6a is a negative pole and the terminal 6b is a positive pole. Thus, the diode D₁ is off, creating a circuit corresponding to the negative half cycle through the antenna coil 6. The drive circuit 8b thus operates by a voltage from the capacitor 5 to drive the transistor Tr.

As a result, the load modulation is performed on the negative half cycle, and the positive half cycle is assigned for a charge cycle of the capacitor 5 as shown in FIG. 2B. The waveform on the positive half cycle thus has a constant amplitude, and the power supply and the load modulation are performed on a different cycle: positive and negative, respectively. Hence, the power voltage V_{DD} of the capacitor 5 is unaffected by the load modulation. Further, since the charging and the load modulation are performed alternately, a half-cycle each, it is possible to supply a stable voltage for the load-modulation. Errors in receiving data at the external device are thereby reduced.

The explanation of this embodiment focuses on data transmission from the wireless communication IC 1. Though IC tags and so on mainly transmit data in this way, contactless IC cards containing the wireless communication IC 1 transmit data after receiving a command such as data transmission request, thus exchanging data with each other. Since the operation of receiving data from the external device in the wireless communication IC 1 is not directly related to this invention, its description is omitted in this embodiment shown in FIG. 1.

The embodiment explained in the foregoing explains a case where the positive half cycle is assigned for the capacitor charging and the negative half cycle for the load modulation; however, the cycles may be oppositely assigned. In this case, the logic circuit 3 and the load modulation circuit 8 operate by electric power from the capacitor 5 as a negative supply. According to this, the transistors may be changed from P-channel to N-channel and so on. Further, a bipolar transistor may be used for each transistor.

The operation of this embodiment becomes reverse by setting a logic at the output terminal 3c of the logic circuit 3 to a negative logic. It is thereby possible in this embodiment also to change the transistors from P-channel to N-channel and place them in the downstream of the series resistor, for example, to perform the same operation as above. Thus, the transistor in this embodiment is not restricted to P-channel.

Further, the present invention may be applied to any circuit that transmits data from the wireless communication IC 1 to the external device in a close-coupled or proximity system, regardless of a data transmission distance.

The carrier frequency used in this embodiment is just one example, and a standardized frequency of 4.91 MHz for the close-coupled type may be used, for example.

The wireless communication IC 1 may be available for use in contactless IC cards, IC tags, and other media including electronic keys in a security system. Further, the antenna coil on the wireless communication IC 1 may be in any form, including a coil-on-chip antenna mounted on a chip, and an external antenna connected to a terminal of the wireless communication IC 1.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A wireless communication integrated circuit (IC) for exchanging data with an external device by receiving a radio signal having a given carrier frequency as power supply from the external device through an antenna, comprising:
a capacitor storing electric power;
a diode placed between an end of the antenna and the capacitor, supplying a charge current of the radio signal to the capacitor on a half cycle of the radio signal; and
a load modulation circuit driven by receiving power supply from the capacitor on another half cycle of the radio signal.

2. A wireless communication integrated circuit (IC) for exchanging data with an external device by receiving a radio signal having a given carrier frequency as power supply from the external device through an antenna, comprising:
a capacitor for storing electric power;
a diode placed between an end of the antenna and the capacitor, supplying a charge current of the radio signal to the capacitor on a half cycle of the radio signal; and
a load modulation circuit comprising a series circuit of a first transistor and a first resistor in parallel to the antenna, and a drive circuit connected to the end of the antenna, for on/off driving of the first transistor by receiving power supply from the capacitor on another half cycle of the radio signal.

3. A wireless communication IC according to claim 2, wherein resistance of the first resistor and on-state resistance of the first transistor are selected to modulate the radio signal by several percent to several tens of percent, and the wireless communication IC receives the radio signal in close-coupled to the external device.

4. A wireless communication IC according to claim 3, wherein
the first transistor is a P-channel transistor,
resistance of the first resistor is several hundreds of ohms,
the drive circuit is a series circuit of a second transistor comprising a P-channel transistor connected between a cathode of the diode and the end of the antenna, a second diode, and a second resistor, and
a connection of the second diode and the second resistor is connected to a gate of the first transistor.

5. A wireless communication information storage medium for exchanging data with an external device by receiving a radio signal having a given carrier frequency as power supply from the external device through an antenna, comprising:
an antenna receiving a radio signal having a given carrier frequency from the external device,
a capacitor storing electric power;
a diode placed between one end of the antenna and the capacitor, supplying a charge current of the radio signal to the capacitor on a half cycle of the radio signal; and
a load modulation circuit driven by receiving power supply from the capacitor on another half cycle of the radio signal.

6. A wireless communication information storage medium for exchanging data with an external device by receiving a radio signal having a given carrier frequency as power supply from the external device through an antenna, comprising:
an antenna receiving a radio signal having a given carrier frequency from the external device,
a capacitor for storing electric power;
a diode placed between an end of the antenna and the capacitor, supplying a charge current of the radio signal to the capacitor on a half cycle of the radio signal; and
a load modulation circuit comprising a series circuit of a first transistor and a first resistor in parallel to the antenna, and a drive circuit connected to the end of the antenna, for on/off driving of the first transistor by receiving power supply from the capacitor on another half cycle of the radio signal.

7. A wireless communication information storage medium according to claim 6, wherein resistance of the first resistor and on-state resistance of the first transistor are selected to modulate the radio signal by several percent to several tens of percent, and the wireless communication IC receives the radio signal in close-coupled to the external device.

8. A wireless communication information storage medium according to claim 7, wherein
the first transistor is a P-channel transistor,
resistance of the first resistor is several hundreds of ohms,
the drive circuit is a series circuit of a second transistor comprising a P-channel transistor connected between a cathode of the diode and the end of the antenna, a second diode, and a second resistor, and
a connection of the second diode and the second resistor is connected to a gate of the first transistor.
